(19) United States
(12) Patent Application Publication
(10) Pub. No.: US 2016/0264455 A1
(43) Pub. Date: Sep. 15, 2016

(54) SUBSTRATE COATED WITH A NOISE-OPTIMIZED GLASS-BASED COATING AND METHOD OF PRODUCING SUCH A COATING

(71) Applicant: SCHOTT AG, Mainz (DE)

(72) Inventors: Urban WEBER, Weiler bei Bingen (DE); Silke KNOCHE, Saulheim (DE); Roland DUDEK, Bad Kreuznach (DE); Thomas KORB, Partenheim (DE); Stephan CORVERS, Oestrich-Winkel (DE)

(73) Assignee: SCHOTT AG, Mainz (DE)

(21) Appl. No.: 15/066,650

(22) Filed: Mar. 10, 2016

(30) Foreign Application Priority Data
Mar. 10, 2015 (DE) 102015103460.3

(51) Int. Cl. C03C 17/04; H05B 3/68; H05B 3/74; H05B 6/12

(52) U.S. Cl. CPC C03C 17/04; H05B 6/1209; H05B 3/688; H05B 3/74; C03C 2217/29; C03C 2217/72; C03C 2218/119; C03C 2218/32

(57) ABSTRACT

Substrates of glass or glass ceramic are disclosed which are coated with decorations, also methods for preparing such coatings are disclosed, wherein the decorations are optimized with respect to their acoustic characteristics in such a way that in particular when displacing cookware on induction cooking surfaces the subjective noise feeling is minimized, as possible.

### CROSS REFERENCES TO RELATED APPLICATIONS

This application claims priority from German patent application 10 2015 103 460.3, filed on Mar. 10, 2015. The entire content of this priority application is incorporated herein by reference.

### BACKGROUND OF THE INVENTION

1. Field of the Invention

The invention relates to a coated substrate, preferably of glass or glass ceramic comprising a noise-optimized glass-based coating. The invention also relates to a method of coating a substrate, preferably of glass or glass ceramic with a noise-optimized glass-based coating. The invention further relates to the use of a glass-based coating for generating a noise-optimized coating on a surface of a substrate, preferably consisting of glass or glass ceramic.

2. Description of Related Art

Cooktops of glass ceramic or special glass are designed colored at their surfaces, partially due to aesthetic reasons, partially for differentiation of different cooking device manufacturers, partially due to specific statutory stipulations which require a marking of the cooking zones. Due to the high temperatures at the cooktops, in particular in the cooking zones, up to about 700° C., depending on the heating system and the cooking situation, for the colored design only enamel-based colors or enamel decorations are suitable.

Enamel-based decorations on cooktop surfaces have been found to be disadvantageous with respect to noises resulting from the shifting of cookware, such as pots or pans which are conceived as unpleasant. This problem is of particular relevance in the design of so-called variable cooktops, e.g. induction-based, but also heated in different ways, wherein no fixed cooking zone positions are defined, but a selective shifting of the cookware to freely selectable cooking positions is possible. Up to now there were predefined cooking zones which usually marked the space of the cookware by circular cooking zone surroundings. With such a design the user did not have any reason for shifting the cookware, since outwardly from these cooking zones no heating power could be generated. However with the variable cooktops a region being larger than a prior art cooking zone is marked by means of decorating colors/patterns, and therein one or more pots of any size can be selectively placed and heated. Below the variable cooktop for instance several induction coils are provided, preferably many small coils, but at least two coils, which can be flexibly coupled together and which can heat the complete variable region or only partial regions. Depending on whether several small pots or a small and a large one or a roasting pan will be heated, the respective heating elements are interconnected. The variable cooktops can also be obtained by different heating designs, such as irradiation heating and/or can be heated by combinations of different heating systems. Such variation in the placing possibilities of the cookware leads the user to more frequently displace the cookware which leads to the noises mentioned above by the decorations on the cooktop surface.

In the prior art when designing decorations for the coating of substrates of glass or glass ceramic up to now the following objects were aimed at:
a chemical/physical compatibility with the substrate to be imprinted (e.g. zero elongation glass ceramic);
processing feature (preparation, imprinting, firing in combination with the ceramizing process of the substrate etc.),
the color/aesthetic demands of the cookware manufacturer;
the fulfillment of several performance characteristics, such as abrasion resistance, temperature resistance, adherence, mechanical strength of the imprinted substrate, resistance against chemically aggressive substances, cleanability.

In particular, with respect to the optimization of the performance characteristics “cleanability” and “abrasion” up to now the development aimed at decorations having a low roughness.

Thus the JP 2007101134 and JP 2014037926 provide relations between an improved cleanability of the decoration and characteristics with respect to the roughness of the decoration. According to JP 2003217811 and JP 2004170754 apart from an improved cleanability also optical characteristics of the decoration, such as light scattering and transmission are emphasized. From DE 103 38 165 A1 a decoration is known which leads to a small abrasion of the pot bottom material due to selectively adjusted roughness characteristics, and consequently to a lower contamination tendency of the decoration. According to DE 10 2004 002 766 A1 several advantages of thermal, chemical and abrasive nature are attributed to small roughness characteristics of the decoration.

A selective adjustment of increased roughness is done in the frame of developments of haptic design structures which shall simplify the usability of cooking fields. This is described in DE 10 2011 115 379 A1.

From DE 10 2013 102 221 A1 in addition particularly scratch-resistant amorphous and transparent top coatings on glass or glass ceramic substrates are known having a particularly low surface roughness. Herein the advantage shall in particular lie in the reduction of mechanical scratch sensitivity of cooktop surfaces.

However in none of the mentioned documents any investigations with respect to noise generation during the shifting of cookware are mentioned. Up to now no investigations at all with respect to roughness values of decorations or layers on cooktops, working surfaces or similarly used surfaces with respect to the noise generation during the displacement of cookware, in particular when also including additional topographical details of the surface structure are known.

### SUMMARY OF THE INVENTION

In view of this it is an object of the invention to disclose a coated substrate, preferably of glass or glass ceramic, comprising a glass-based decoration that presents a noised-optimized behavior when shifting objects thereon.

It is a second object of the invention to disclose a coated substrate, suitable as a variable cooktop, consisting of a glass or glass ceramic substrate, comprising a glass-based decoration that presents a noised-optimized behavior when shifting cookware thereon.

It is a third object of the invention to disclose a glass or glass ceramic cooktop, the noise generation of which during the displacement of cookware thereon being modified such that an unpleasant psycho-acoustical sensation of noises generated during shifting of cookware thereon is reduced.

These and other objects according to one aspect are solved by a coated substrate, preferably of glass or glass ceramic, comprising a noise-optimized glass-based decoration, preferably having an acuteness<3 acum and/or a loudness<7 sone, measured according to DIN 45631/A1:2010-03 and DIN 45692:2009-08 on said substrate with outer dimensions 500×550 mm² coated with said decoration, while displacing a steel-enamel pot at a speed of 0.08 m/s on said coated substrate, said steel-enamel pot having an enamel bottom with a diameter of the stand bottom of 17 cm, a height of 8.5 cm, an inner diameter at the upper rim of 20 cm, having an empty mass of 1.6 kg and an extra mass of 1 kg received within the inside, said enamel bottom having a Vicker's hardness of 635±50 HV 0.1/10 according to DIN EN ISO 6507-1 and a roughness Ra between 0.2 and 0.9 μm according to DIN EN ISO 4288:1998.

Such a pot of the type Silargan roasting pot Accento, which was used in mint condition, is marketed by the company Silit, Germany. It has an enamel bottom with a Vicker's hardness of 635±50 HV 0.1/10 according to DIN EN ISO 6507-1 and a roughness Ra between 0.2 and 0.9 μm according to DIN EN ISO 4288:1998, a diameter of the stand bottom of 17 cm, a height of 8.5 cm, an inner diameter at the upper rim of 20 cm and an empty weight of 1.6 kg.

It was found that with a substrate coated in such a way a cooktop can be provided that allows to generate a noise optimization when displacing cookware at normal speeds which is not perceived as unpleasant by the user.

According to another aspect of the invention the acuteness is<3 acum and also the loudness is<7 sone.

It was found that with such an acuteness and such a loudness a displacement of cookware on induction cooking surfaces of glass ceramic can be done particularly noise-reduced without any unpleasant feeling.

According to a further aspect of the invention the substrate coated with the decoration at its decoration surface has a roughness amount measured by a white light interference microscopy rms in the range of 10 mm⁻¹ to 20 mm⁻¹, smaller than 0.1 μm (rms_{10 mm-1 . . . 20 mm-1}<0.1 μm), preferably rms_{10 mm-1 . . . 20 mm-1}<0.05 μm, particularly preferred rms_{10 mm-1 . . . 20 mm-1}<0.02 μm and a roughness amount rms in the range of 20 mm⁻¹ to 50 mm⁻¹ smaller than 0.45 μm (rms_{20 mm-1 . . . 50 mm-1}<0.045 μm), preferably rms_{20 mm-1 . . . 50 mm-1}<0.03 μm, particularly preferred rms_{20 mm-1 . . . 50 mm-1}<0.015 μm.

It was found that with such a surface topography the acuteness of the displacement noise is particularly reduced.

A correlation of the acuteness with roughness characteristics Rz and Ra determined in the prior art according to DIN 4768 cannot be found, such as explained in the following. However with the roughness characteristics mentioned above a correlation with the acuteness can be made. In particular the acuteness determines the unpleasant noise feeling.

By optimizing these roughness ratios the decoration can be positively influenced with respect to the hearing sensation “acuteness”.

According to a further aspect of the invention the coating preferably consists of a fired glass frit on the basis of silicate glasses, borosilicate glasses, zinc silicate glasses, zinc borate glasses, zinc borosilicate glasses, bismuth borosilicate glasses, bismuth borate glasses, bismuth silicate glasses, phosphate glasses, zinc phosphate glasses, aluminosilicate glasses, or lithium aluminosilicate glasses.

Basically, various decoration glasses, as mentioned above, can be utilized to provide a noise-optimized decoration on a substrate, or to obtain the mentioned topographical characteristics rms_{10 mm-1 . . . 20 mm-1 and} rms_{20 mm-1 . . . 50 mm-1}, respectively.

According to a further aspect of the invention the glass frit contains additions of pigments, fillers and/or structure-generating particles.

In particular an addition of pigments is desired for generating on cooktops boundaries and manufacturer-specific specifications, such as trademark indications, etc. Herein in particular the addition of pigments leads to considerably increased contrasts and color providing possibilities.

In particular the addition of structure-generating particles, in particular glass spheres, in a different modification of the invention can lead to particular noises required with adjustable acuteness and loudness which may be utilized as an acoustic signal. Herein, in particular noises can be generated having a large acuteness for generating attention, which however when compared with prior art decorations are “more quiet” (i.e. have a reduced loudness) to avoid an unnecessary irritation of the user.

Preferably the substrate consists of glass or a glass ceramic, in particular a LAS glass ceramic. An LAS glass ceramic is understood as a lithium-aluminosilicate glass ceramic (partially also designated as lithium-aluminum-silicate glass ceramic) which at suitable composition and ceramization in a particular temperature region has a strongly reduced thermal extension which can be close to zero. For instance the applicant manufactures and markets an LAS glass ceramic under the trademark Ceran® for application with cooktops.

The substrate coated according to the invention is in particular suitable for variable cook surfaces, in particular for variable induction cook surfaces which by means of a suitable coil arrangement allow for a free displacement and/or freely selectable displacement possibilities of the cookware. Herein variable cook surfaces are understood as cook surfaces having at least one region, wherein one or more cooking pots of any size can be selectively placed and heated. In particular this is realized in that below the variable cook surfaces for instance several induction coils, preferably many small, but at least two coils, are arranged which can be interconnected independently and which can heat the complete variable range or only partial range(s) thereof. However, the variable cooking surfaces can be also obtained by different heating systems, such as irradiation heating and/or by combinations of different heating systems.

According to a further configuration of the invention the decoration comprises a glass flux of a base glass comprising at least the following components (in weight percent on oxide basis):

| | |
|---|---|
| SiO₂ | 44-75 |
| Al₂O₃ | 0-25 |
| B₂O₃ | 0-30 |
| Li₂O | 0-12 |
| Na₂O | 0-15 |
| K₂O | 0-10 |
| CaO | 0-12 |
| MgO | 0-9 |
| BaO | 0-27 |
| SrO | 0-4 |
| ZnO | 0-20 |
| TiO₂ | 0-5 |
| ZrO₂ | 0-7 |
| As₂O₃ | 0-1 |
| Sb₂O₃ | 0-15 |
| F | 0-3 |
| H₂O | 0-3. |

Herein the base glass preferably may comprise at least 1 wt.-%, particularly preferred at least 2 wt.-% of Al₂O₃.

According to a further aspect of the invention the base glass comprises at least 1 wt.-%, preferably at least 5 wt.-% of B₂O₃.

According to a further aspect of the invention the base glass comprises at least 1 wt.-% of an alkali oxide selected from the group consisting of Na₂O, K₂O, Li₂O, and mixtures thereof.

In addition the base glass may comprise at least 1 wt.-% of an oxide selected from the group consisting of CaO, MgO, BaO, SrO, ZnO, ZrO₂, TiO₂, and mixtures thereof.

In addition, the decoration may comprise a glass flux of a base glass comprising at least the following components (in wt.-% on oxide basis):

| | |
|---|---|
| SiO₂ | 6-65 |
| Al₂O₃ | 0-20 |
| B₂O₃ | 0-40 |
| Li₂O | 0-12 |
| Na₂O | 0-18 |
| K₂O | 0-17 |
| CaO | 0-17 |
| MgO | 0-12 |
| BaO | 0-38 |
| SrO | 0-16 |
| ZnO | 0-70 |
| TiO₂ | 0-5 |
| ZrO₂ | 0-5 |
| Bi₂O₃ | 0-20 |
| CoO | 0-5 |
| Fe₂O₃ | 0-5 |
| MnO | 0-10 |
| CeO₂ | 0-3 |
| F | 0-6. |

The coating of the substrate may be done at full surface. However, basically only a surface fraction of 3% to 100% of the substrate is covered at its surface with a decoration.

In addition the invention is solved by a method of decorating a substrate, preferably of glass or glass ceramic, in particular for a variable cooking surface, particularly preferred for a variable induction cooking surface of glass ceramic comprising a noise-optimized glass-based decoration having a low acuteness and loudness, wherein the glass frit is ground to a particle size of D90 of 10 nanometers to 50 micrometers, preferably of 20 nanometers to 20 micrometers, particularly preferred of 2 to 10 micrometers, is mixed with a dispersing agent and is homogenized substantially free of agglomerates, thereafter is applied to a surface of the substrate and burnt-in, preferably in such a way that the coated substrate has an acuteness<3 acum and/or a loudness<7 sone, measured according to DIN 45631/A1:2010-03 and DIN 45692:2009-08 on the substrate coated with the decoration having the outer dimensions 500×550 mm, utilizing a steel-enamel pot having an enamel bottom of Silit, of the type Silargan roasting pot 20 cm Accento having a diameter of the standing bottom of 17 cm and a mass of 1 kg received, while displacing the pot at a speed of 0.08 m/s.

Such a pot of the type Silargan roasting pot Accento, which was used in mint condition, is marketed by the company Silit, Germany. It has an enamel bottom with a Vicker's hardness of 635±50 HV 0.1/10 according to DIN EN ISO 6507-1 and a roughness Ra between 0.2 and 0.9 μm according to DIN EN ISO 4288:1998, a diameter of the stand bottom of 17 cm, a height of 8.5 cm, an inner diameter at the upper rim of 20 cm and an empty weight of 1.6 kg.

It was found that with such a method in particular a variable induction cooking surface made of glass ceramic can be produced which is optimized with respect to the sensed displacement noise.

According to a further preferred aspect herein the decoration is filed in such a way that the surface of the roughness amount rms determined by white light interference microscopy is in the range of 10 mm⁻¹ to 20 mm⁻¹ smaller than 0.1 micrometers (rms_{10 mm-1 . . . 20 mm-1}<0.1 μm), preferably rms_{10 mm-1 . . . 20 mm-1}<0.05 m, particularly preferred _{rms 10 mm-1 . . . 20 mm-1}<0.02 μm, and a roughness amount rms in the range of 20 mm⁻¹ to 50 mm⁻¹ smaller than 0.045 micrometers (rms_{20 mm-1 . . . 50 mm-1}<0.045 μm), preferably rms_{20 mm-1 . . . 50 mm-1}<0.03 μm, particularly preferred rms_{20 mm-1 . . . 50 mm-1}<0.015 μm.

When the glass flux during burning-in is adjusted such that such roughness amounts result, then in this way the acuteness of the cooking surface can be kept sufficiently small so that the displacement noise during the displacement of cookware is not sensed as unpleasant.

According to a further preferable aspect of the invention the grinding and homogenizing of the glass frit is performed such that substantially no agglomerates>20 micrometers, preferably>10 micrometers, particularly>5 micrometers are present.

In this regard “substantially no” is understood so that the volume share of such agglomerates is smaller than 1%, preferably smaller than 0.1%, particularly preferred smaller than 0.01%.

It was found that in particular the avoiding of agglomerates is substantial to achieve a small acuteness and a small loudness, to keep sensed noise during displacement of the cookware as small as possible.

Further preferred for the grinding of the glass frit a dry grinding method is preferred, in particular sphere grinding, jet-grinding, counter-grinding, or air-grinding. In particular the grinding with a dry attritor in combination with a sifter is preferred to obtain a small particle distribution without agglomerates.

It was found that in particular by means of a dry grinding an agglomeration can be avoided which occurs when using wet grinding with subsequent drying. Since in particular with the produced decorations a surface as smooth as possible not including any unevenness is important, dry grinding methods are particularly suitable to avoid undesired particles at the surface which are due to agglomerates.

According to a further aspect of the invention additional materials, in particular pigments, fillers and/or structure-providing particles are admixed and homogenized together therewith.

As fillers in particular SiOₓ-particles, aluminum oxide particles, pyrogene silicic acids, lime sodium bicarbonate particles, alkali alumino silicate particles, polysiloxane spheres, borosilicate glass spheres and/or hollow glass spheres come into consideration.

As pigments in particular color providing pigments configured as metal oxides can be admixed, in particular cobalt oxides/spinels, cobalt aluminum spinels, cobalt aluminum zinc oxides, cobalt aluminum silicon oxide, cobalt titanium spinels, cobalt chromium spinels, cobalt aluminum chromium oxides, cobalt nickel manganese iron chromium oxides/spinels, cobalt nickel zinc titanium aluminum oxides/spinels, chromium iron nickel manganese oxides/spinels, cobalt iron chromium oxides/spinels, nickel iron chromium oxides/spinels, iron manganese oxides/spinels, iron oxides, iron chromium oxides, iron chromium zinc titanium oxides, copper chromium spinels, nickel chromium antimonite titanium oxides, titanium oxides, zirconium silicon iron oxides/spinels. As pigments preferably absorption pigments, in particular also plate-shaped or pin-shaped pigments, coated effect pigments are utilized which can be admixed to the glass frit as individual pigments or also as a pigment mixture.

However the inventors found that for generating a noise-optimized surface decoration it is particularly important that no unmolten particles are contained in the surface of the decoration. The pigments and the fillers herein are surrounded/embedded by the decoration glass, in particular the decoration surface is not perforated by pigments or fillers. The pigments and fillers during the melting process are sufficiently wetted with the liquid glass frit so that for instance a floating of the pigments/fillers is avoided which would lead to elevations or indentations in the decoration surface. Due to this reason preferably to the glass frit after the grinding a maximum of 20 wt.-% of pigments and fillers, preferably 10 wt.-%, more preferred of 7 wt.-%, particularly preferred of 5 wt.-% is admixed.

Since in particular the pigments are partially higher melting components which during the normal melting procedure of the decorations are not dissolved within the glass melt, in this way by a suitable limitation of the pigments and additional additives it can be ensured that there are no elevations at the surface of the decorations which would effect the loudness or acuteness detrimentally during displacement of cookware on the decoration surface. Herein preferably an addition of pigments, fillers and further additives is completely dispensed with.

If however, due to the desired coloring, an addition of pigments is absolutely necessary, even with a higher percentage, then according to a further preferred aspect of the invention the pigments and possibly further fillers are melted initially together with the glass flux, are thereafter ground to obtain a glass frit, before the decoration is applied onto the glass surface. The coloration herein is generated by the crystallization of color bodies during the burning-in process of the decoration after the smooth flowing of the glass frit, wherein the crystals mainly are generated within the decoration layer and not at the surface, and thus are embedded within the glass flux.

In this way in particular also higher proportions of color providing pigments are fully dissolved within the glass flux and can be integrated therewith, without remaining non-molten particles at the surface during later melting of the decoration at the substrate surface, which would thus have a detrimental effect on the noise generation.

For applying the decoration onto the substrate surface preferably a liquid coating method can be used, in particular screen printing, ink jet printing, offset printing, pressure printing, tampon printing, spray printing, dip-coating, tear-off printing methods, applying by doctor, flooding, spin-coating.

In particular a coating by means of screen printing is a process suitable for large volume production, wherein screens with a size of 100 to 140 threads per centimeter are preferred. For obtaining a substantially agglomerate-free homogenizing of the color paste, preferably a rolling mill or a dispersion kneader may be used.

After application the decoration is burnt-in, preferably at a temperature range of 600° C. to 1200° C., preferably for a time span of 1 minute to 4 hours.

Herein the burning-in temperature is preferably adjusted to the substrate so that a smooth, homogenous melting of the decoration to a very smooth surface occurs from which as few particles as possible protrude. Herein preferably the firing temperature and time are adjusted to the composition of the decoration. The firing of the decoration usually occurs at temperatures which are below the softening temperature of the substrate, but are sufficiently high to ensure a melting of the glaze and intimate connection with the surface of the substrate.

After applying the decoration it is preferably dried at elevated temperature (e.g. 150 to 200° C.) before burning-in.

The respective substrate may be a glass or a glass ceramic which is transparent, colored transparent, translucent or opaque, having a coefficient of thermal expansion in the range of 20-300° C. of 7×10⁻⁶/K, preferably 6.5×10⁻⁶/K, more preferably of ≦5×10⁻⁶/K, particularly preferred in the range of −1×10⁻⁶/K to 4.5×10⁻⁶/K. Particularly preferred an LAS (lithium aluminum silicate) glass ceramic is used. The thickness of the substrates is 0.1 to 40 mm, preferably 1 to 10 mm, particularly preferred 3 to 6 mm.

In a further aspect of the invention a glass ceramic, in particular a LAS glass ceramic is used as the substrate onto which the decoration is applied in the green-glass condition, and thereafter the decoration is fired, wherein simultaneously the green glass is ceramized. It should be noted that “green glass” is a common term for glasses from which glass ceramics are generated by the ceramization process. Thus the term “green glass” is not limited to particular glass/glass ceramic colors.

In this way a particular efficient production is ensured. Also an intimate connection of the decoration with the glass surface is ensured and a detrimental modification of the substrate by the firing process is avoided.

For the simultaneous burning-in and ceramizing herein preferably a temperature region of 850 to 1200° C., preferably of 900 to 1150° C. is used, wherein the time span is usually 5 to 240 minutes, preferably 10 to 60 minutes, particularly preferred 10 to 30 minutes.

Alternatively, it is also possible to use a glass ceramic, in particular a LAS glass ceramic as a substrate, onto which the decoration is applied in the ceramized state, and thereafter the decoration is burnt-in.

If the burning-in of the decoration is done on the glass ceramic which already has been ceramized, then the firing temperature usually is lower, so that preferably a temperature of 600 to 1200° C., preferably of 700 to 900° C. is used, over a time span of 1 to 240 minutes, preferably of 2 to 120 minutes.

Finally the invention also discloses a utilization of a glass-based decoration for generating a noise-optimized coating on a surface of a substrate of glass or a glass ceramic, which in particular is suitable for a variable cooktop, in particular a variable induction cooking surface, having a low acuteness and loudness, in particular an acuteness<3 acum and/or a loudness<7 sone, measured according to DIN 45631/A1:2010-03 and DIN 45692:2009-08 on a substrate coated with decoration having the outer dimensions of 500 mm×500 mm, while using a steel-enamel pot having an enamel bottom from the company Silit of the type Silargan roasting pot 20 cm Accento having a diameter of the stand bottom of 17 cm and a mass of 1 kg received inside, while displacing the pot at a speed of 0.08 m/s.

Finally the decoration preferably is used for generating a coating having a roughness portion determined by white light interference microscopy rms in the range of 10 mm⁻¹ to 20 mm⁻¹ of smaller than 0.1 micrometers (rms_{10 mm-1 . . . 20 mm-1}<0.1 μm), preferably rms_{10 mm-1 . . . 20 mm-1}<0.02 μm, and a roughness portion rms in the range of 20 mm⁻¹ to 50 mm⁻¹ of smaller than 0.04 μm (rms_{20 mm-1 . . . 50 mm-1}<0.04 μm), preferably rms_{20 mm-1 . . . 50 mm-1}<0.015 μm.

It will be understood that the afore-mentioned features and to be described hereinafter cannot only be utilized in the given combination, but also in different combinations or independently, without departing from the scope of invention.

### BRIEF DESCRIPTION OF THE DRAWINGS

Further features and advantages of the invention can be taken from the subsequent description of preferred embodiments while referring to the drawings. In the drawings show:

FIG. 1 decoration patterns on a substrate surface having different surface layouts;

FIG. 2 an alternative surface layout for a screen printing pattern for a decoration having different surface layouts;

FIG. 3 an alternative embodiment of a screen printing pattern for a decoration in the shape of a point pattern layout with a square pattern having different surface layouts; and

FIG. 4 different screen printing patterns for a decoration with sub-stochiometric grid pattern with different surface layouts.

### DETAILED DESCRIPTION

### Employed Measuring Methods

The psycho-acoustic characteristics of the substrates coated with the decoration, i.e. the human noise feeling during the displacement of cookware on the surface are described by two parameters, the acuteness and the loudness.

The experimental determination of the parameter acuteness is described in DIN 45692:2009-08, Technical Measurement Simulation of the Hearing Feeling Acuteness: A high acuteness and a high loudness usually are sensed as unpleasant. The determination of the loudness was done according to DIN 45631/A1:2010-03.

The recording of the psycho-acoustic parameters in detail is done herein according to the following method:

A cooking surface with the outer dimensions 500 mm×550 mm and the thickness 4 mm, imprinted with the decoration to be investigated is placed on a rubber-coated metal frame having the same dimensions. The design of the metal frame and the rubber application herein is substantially done according to the instructions given e.g. in DIN 52306 with respect to the holding device. The frame and the plate herein are decoupled as far as possible from further holding devices with respect to acoustic oscillations, e.g. by using fleece covers.

A steel-enamel pot in mint condition having an enamel bottom of the company Silit, Silargan roasting pot 20 cm Accento having a diameter of the stand bottom of 17 cm is additionally ballasted by a mass of 1 kg of a metallic material adhering to the inside. In mint condition is to be understood that the pot has undergone less than 50 checking cycles of the examination procedure to be described in the following.

Such a pot of the type Silargan roasting pot Accento, which was used in mint condition, is marketed by the company Silit, Germany. It has an enamel bottom with a Vicker's hardness of 635±50 HV 0.1/10 according to DIN EN ISO 6507-1 and a roughness Ra between 0.2 and 0.9 μm according to DIN EN ISO 4288:1998, a diameter of the stand bottom of 17 cm, a height of 8.5 cm, an inner diameter at the upper rim of 20 cm and an empty weight of 1.6 kg.

The pot is guided circularly across the decorated cooking surface without self-rotation, wherein the circle radius, measured from the circle center to the pot bottom center is 26 mm. The frequency of the circular motion is standardized 0.5 Hz (in the Table designated as “slow”), in some cases the double frequency (1 Hz) was used (in the Table: “fast”), this corresponds to displacement speeds of about 0.08 or 0.16 m/s, respectively, such as typically occurring in day-to-day use of a cooking surface.

Alternatively also a linear motion with a frequency of also 0.5 Hz and a displacement path of 50 mm was used (about 0.1 m/s). The noise recording occurs according to the cited norms, wherein the level recording is done using a microphone that is suspended vertically 700 mm above the cooktop center. For analyzing the noise recordings a continuous recording time of 10 s are used. The complete experimental set-up is within a noise-isolated and noise-absorbing room. Also smaller substrate surfaces were investigated (dimensions: 250 mm×380 mm, thickness 4 mm); herein depending from the dimensions lower loudness values, however similar acuteness values result. As far as not indicated differently, the loudness values (in particular in the claims) always refer to the largest surface 500 mm×550 mm.

For a comparative evaluation of substrates coated with the decoration the topographic data of the decoration surfaces were used, namely the roughness values Ra, Rz (cf. DIN 4768), determined by a white light interference microscopy, to determine the effects on the acoustic characteristics.

However, it was found that these values do not correlate with the psycho-acoustic parameters important for a disturbing hearing feeling, instead, however a more detailed description of the topography is necessary.

Put another way it is not sufficient to utilize the decoration described in the prior art as having low values of Ra and Rz, to obtain a noise-optimized surface of a substrate coated with a decoration.

To determine the novel roughness parameters which correlate with the psycho-acoustic values, the white light interference microscopy was used, to obtain topography values on surfaces of 3.12 mm×3.11 mm by stitching (lateral resolution 0.8 μm).

The white light interference microscopy analyzes were performed using a white light interference microscope of the type NewView 200 CHR of the Zygo Corporation. For evaluation the 32-bit software MetroPro version 8.3.5 under Windows XP SP 3 was used.

The measurement/output value parameters were determined as follows:
optical parameters: 50×-lens, zoom-factor 0.5×, camera: 320×200 picture points resolution 0.8 μm,
for determining the topography values of the surfaces on a surface of 3.12 mm×3.11 mm so-called “stitching” was used (stringing together individual (smaller) topography recordings), namely with the following parameters: Cols 15, rows 20, overlap 20%. From this the topographic data with 3900±20 rows and columns (a slightly amended selection of the parameters or an averaging across the few rows/columns or the utilization of a smaller measuring window [however at least 1 mm] should have no significant influence on the result of the investigation).

From the determined topographical data the so-called Power Spectral Density functions (PSD) can be computed. This value is e.g. defined within the norm ISO 10110-8:2010(E). When the topographic data describe a heightness profile with z=z(x,y) then the (row or column) PSD-functions are defined as follows:

$${PSD}_{1 D , y} ( {f}_{x} ) = {lim}_{L \to ∞} \frac{1}{L} {\vert {\int }_{- L / 2}^{+ L / 2} z ( x , y ) exp ( - 2 πi {f}_{x} x ) d x \vert}^{2}$$

$$or , respectively , \\ {PSD}_{1 D , x} ( {f}_{y} ) = {lim}_{L \to ∞} \frac{1}{L} {\vert {\int }_{- L / 2}^{+ L / 2} z ( x , y ) exp ( - 2 πi {f}_{y} y ) d y \vert}^{2}$$

Since the roughness values of the surface are substantially of stochastic nature for the PSD1D,x and the PSD1D,y substantially the same values result, so that by averaging across the 3900±20 rows and the 3900±20 columns P̅S̅D̅_̅{̅1̅D̅,̅x̅}̅(̅f̅_̅{̅y̅}̅)̅ and P̅S̅D̅_̅{̅1̅D̅,̅y̅}̅(̅f̅ₓ̅)̅ of the PSD, which again can be compounded again to a total average PSD_{1D}(f)=(P̅S̅D̅_̅{̅1̅D̅,̅x̅}̅(̅f̅)̅+P̅S̅D̅_̅{̅1̅D̅,̅y̅}̅(̅f̅)̅)/2.

By virtue of the Parseval Theorem for the rms roughness of the topography the following relation with the PSD-function results:

$${rms}^{2} = {\int }_{0}^{+ ∞} {PSD}_{1 D} ( f ) d f$$

Correspondingly “roughness portions” for any frequency ranges can be determined (in the spatial frequency room, wherein the spatial frequency corresponds to the inverse of the respective wavelength: fx˜1/λx):

$${rms ( {f}_{1} … {f}_{2} )}^{2} = {\int }_{{f}_{1}}^{{f}_{2}} {PSD}_{1 D} ( f ) d f$$

The total roughness rms can correspondingly be computed from the “roughness portions”:

rms²=rms(0 . . . f₁)²+rms(f₁ . . . f₂)²+rms(f₂ . . . f₃)² . . . +rms(f_{N} . . . ∞)²

Since the uncoated substrate surface already has an irregular roughness in the long-wave range, initially long-wave roughness components were filtered out for the analysis (frequency<1 mm⁻¹). From the resulting topography over a wide spectral range the spectral density of the roughness (power spectral density, PSD) can be viewed—average across the x- and y-directions. If the decorated surfaces should be smaller than the surfaces in the evaluation described above (3.1 mm×3.1 mm) then instead also values can be used which were determined using smaller surfaces. However, herein it is important that the averaging of the PSD-function is done across a statistic total population which is equivalent to the one described above (i.e. averaging across at least 2×3900=7800 line profiles).

The roughness portions between 10 mm⁻¹ and 20 mm⁻¹ and between 20 and 50 mm⁻¹, i.e. rms (10 mm⁻¹ . . . 20 mm⁻¹) and rms (20 mm⁻¹ . . . 50 mm⁻¹) can be correlated with the values for the hearing feeling acuteness.

By optimizing these roughness parameters the decoration can be positively influenced with respect to the hearing feeling acuteness.

### Preparation of Decorations and Coating of Substrates According to the Invention

The decorations according to the invention are based on a burnt-in ceramic color. The ceramic color consists of a glass flux which, inter alia, may be mixed with pigments, fillers, structure-generating particles.

The burning-in of the decorations usually is done at temperatures which are below the softening range of the substrate, but are sufficiently high to ensure a melting of the glaze and an intimate connection with the surface of the substrate. One possibility of preparing the glazes rests in the melting of the glass raw materials to a glass, also called glass flux, which after the melting and cooling is ground. The grinding product is designated as glass frit. Such a glass frit usually is mixed with suitable additives, e.g. suspending agents, which serve to assist the application of the enamel powder.

In prior art decorations the color providing pigments usually are admixed to the ground glass frit and are homogenized together therewith.

However, it was found that for the production of noise-optimized decorations the avoiding of additions, such as color providing pigments, is particularly advantageous, or a limitation to a particular portion such as a maximum of 10 wt.-%, respectively. Alternatively, also the pigments can be molten together with the base glasses and can be ground to glass frit. The decorations prepared therefrom showed more advantageous loudness and acuteness values than the decorations of comparable composition, to which the pigments were only admixed after the frit preparation.

For grinding the glass frit different dry and wet grinding technologies can be utilized, e.g. sphere grinders, jet grinders. In particular the dry grinding processes are preferred, such as counter grinding, air grinding or steam jet grinding, to avoid the agglomeration of the ground products during the grinding (to a large extent). In particular the grinding with a dry sphere grinder in combination with a sifter is preferred to obtain a tight particle distribution without agglomerates.

In the following the preferred components of the glaze are discussed in more detail. In the subsequent Tables 1 and 2 different glass compositions are given which may be used as a decoration, i.e. for the coating of glass or glass ceramic substrates.

As a glass frit preferably the following glass types are utilized, e.g. alkali-free and alkali-containing glasses, silicate glasses, borosilicate glasses, zinc silicate glasses, zinc borate glasses, zinc borosilicate glasses, bismuth borosilicate glasses, bismuth borate glasses, bismuth silicate glasses, phosphate glasses, zinc phosphate glasses, aluminosilicate glasses, lithium aluminosilicate glasses. Depending on the firing condition and the carrier material (substrate) the skilled person will select a suitable glazing glass, in particular in such a way that with an adjusted glaze thickness melting on or melting, respectively, of the glaze glasses is ensured. This means for instance that the viscosity values T_{g} and E_{w} of the glass lie below the firing temperature. Preferably, the firing temperature is at least 100° C., preferably at least 150° C., and more preferably at least 200° C. above the softening temperature. The time duration of the firing may be between 1 minute and several hours, depending on the temperature program that is used.

The layer thicknesses of the burnt-in ceramic decorations on the substrates may be between 0.5 and 50 μm, preferably between 1 and 20 μm, particularly preferred between 1 and 7 μm. The decorations may be applied full surface or locally, as structured decorations, such as grids, patterns, characters, symbols etc., may be arranged as a single layer or as several decorations beside each other and/or above each other.

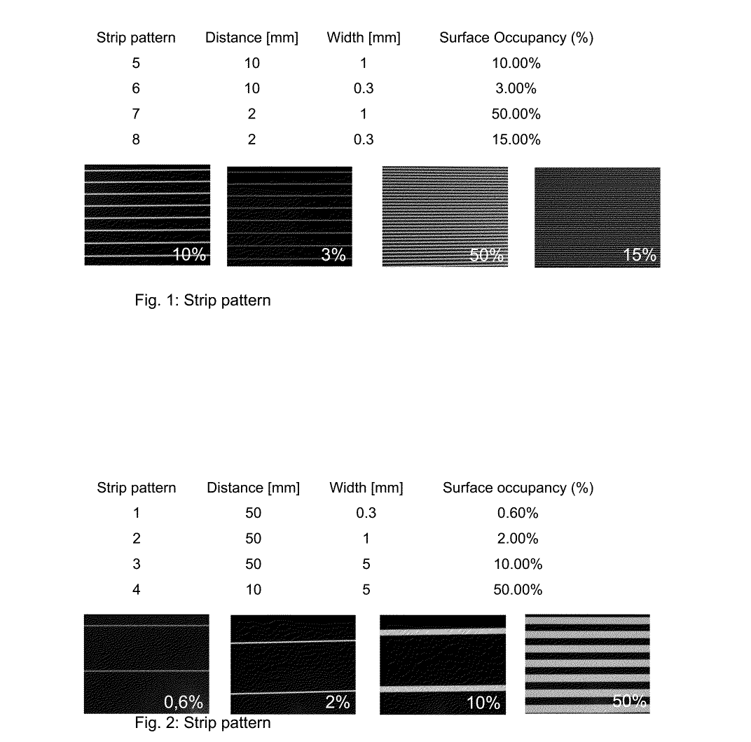

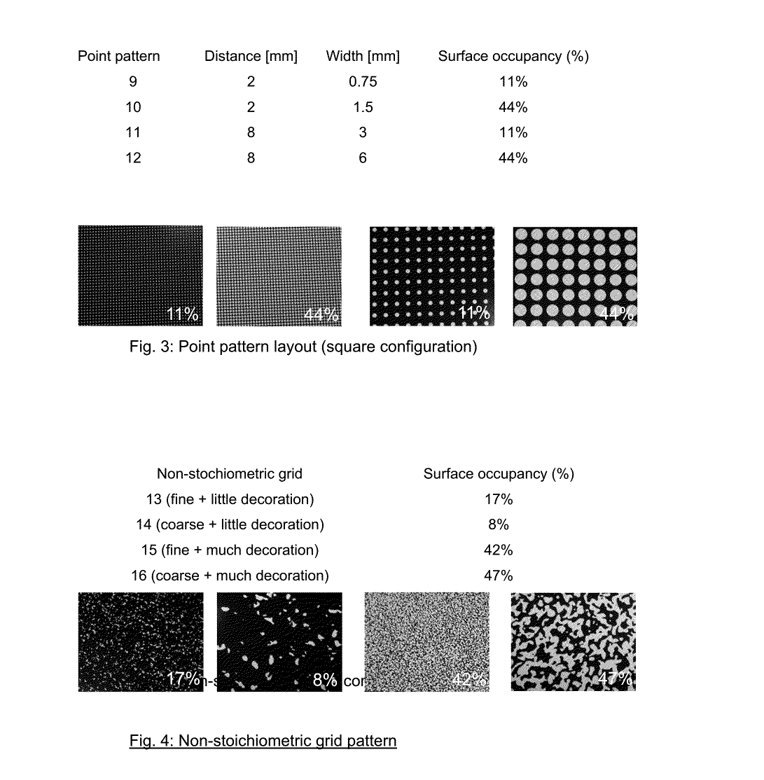

Several decoration patterns which were utilized for the sample coatings are subsequently shown in FIGS. 1 to 4.

Also in addition to the decoration on the substrate surface, decorations may be present on the bottom surface, in particular with transparent substrates. These decorations may for instance be ceramic, sol-gel, silicon, polymer-based, and/or metal oxide/metal layers, may be used individually as well as in combination(s). The decorations on the bottom surface can also be present full surface or only locally, as structured decorations, such as grids, patterns, characters, symbols etc., may be present as individual layer or as several decorations arranged besides each other or above each other.

The application of the decorations preferably is done by using liquid coating methods, such as screen printing, ink jet printing, offset printing, tampon printing, spray methods, dipping coating, roller coating, applying by doctor, flooding, spin coating, but can also be done by tear-off printing methods. The necessary, usually organic additives, evaporate when burning-in the decorations.

As substrates preferably materials are used which comprise glass and/or glass ceramic or consist thereof. Basically the substrates can also consist of composite materials or of reinforced or fiber-reinforced materials, respectively.

The substrates may be admixed with further coatings and/or may serve additional functions. For instance the substrates may be chemically or thermally hardened and/or may comprise functional coatings, such as friction reducing, anti-scratching, easy to clean characteristics. Also treatments or after-treatments, such as mechanical processing, e.g. abrasive processes, polishing processes, or chemical treatment, such as etching are not excluded. The substrates may e.g. contain borings, local protrusions or recesses, preferably outside of the decoration regions on the top surface.

TABLE 1

| Weight-% | Glass A | Glass B | Glass C | Glass D | Glass E | Glass F | Glass G | Glass H | Glass I |
|---|---|---|---|---|---|---|---|---|---|
| SiO₂ | 44-57 | 53-63 | 57-62 | 47-52 | 40-50 | 63-73 | 50-66 | 45-60 | 45-75 |
| Al₂O₃ | 5-25 | 15-25 | 5-8 | 2-6 | 9-15 | 0-7 | 0-20 | 6-17 | 1-10 |
| B₂O₃ | 0-27 | 15-22 | 18-23 | 17-21 | 10-15 | 12-29 | 0-8 | 0-10 | 10-30 |
| Li₂O | 0-10 | 2-7 | 2-6 | 3-5 | 0-4 | 0-6 | 0-12 | 0-7 | 0-5 |
| Na₂O | 0-10 | 0-1 | 0-1 | 1-5 | 1-4 | 0-8 | 7-15 | 0-7 | 0-10 |
| K₂O | 0-10 | 0-1 | 0-4 | 5-10 | 0-3 | 0-8 | 0-3 | 0-7 | 0-5 |
| CaO | 0-4 | 1-4 | 1-2 | 0-2 | 0-3 | 0-5 | 0-10 | 0-12 | 0-4 |
| MgO | 0-3 | 1-4 | 0-2 | 0-1 | 0-3 | 0.1-5 | 3-8 | 0-9 | 0-4 |
| BaO | 0-4 | 0-1 | 0-2 | 0-2 | 16-24 | 0-5 | 0-15 | 13-27 | 1-10 |
| SrO | 0-4 | 1-4 | 0.5-2 | 0-1 | 0-2 | 0-4 | 0-4 | 0-4 | 0-4 |
| ZnO | 0-15 | 1-4 | 0-2 | 0-3 | 8-15 | 0-15 | 0-5 | 3-17 | 0-20 |
| TiO₂ | 0-3 | 0-1 | 0-2 | 0-2 | 0-3 | 0-5 | 0-5 | 0-2 | 0-2 |
| ZrO₂ | 0-7 | 1-4 | 2-5 | 0-2 | 0-4 | 0-5 | 0-5 | 0-7 | 0-7 |
| As₂O₃ | 0-1 | 0-1 | 0-1 | 0-1 | 0-1 | 0-1 | 0-1 | 0-1 | 0-1 |
| Sb₂O₃ | 0-15 | 0-1 | 0-1 | 0-1 | 0-15 | 0-1 | 0-1 | 0-1 | 0-1 |
| F | 0-3 | 0-1 | 0-1 | 0-1 | 0-1 | 0-1 | 0-1 | 0-1 | 0-2 |

TABLE 2

| Weight-% | Glass K | Glass L | Glass M | Glass N | Glass O | Glass P |
|---|---|---|---|---|---|---|
| SiO₂ | 25-55 | 35-65 | 30-54 | 6-20 | 6-15 | 45-65 |
| Al₂O₃ | 3-18 | — | 0-17.5 | 0-5 | — | 0-15 |
| B₂O₃ | 5-25 | — | 13-28 | 20-38 | 20-28 | 5-30 |
| Li₂O | 0-12 | 0-6 | 3-6 | — | — | 0-10 |
| Na₂O | 3-18 | 0-6 | 4-10 | — | — | 0-10 |
| K₂O | 3-18 | 0-6 | 0-2 | — | — | 0-10 |
| CaO | 3-17 | 0-12 | 0-6 | — | — | 0-5 |
| MgO | 0-10 | 0-12 | 0-4 | — | — | 0-5 |
| BaO | 0-12 | 0-38 | — | — | — | 0-20 |
| SrO | — | 0-16 | 0-4 | — | — | 0-16 |
| ZnO | — | 17.5-38 | 3-13 | 35-70 | 58-70 | 0-35 |
| TiO₂ | 0-5 | — | 0-2 | 0-5 | — | 0-5 |
| ZrO₂ | 0-3 | — | 0-2 | 0-5 | — | 0-5 |
| Bi₂O₃ | — | — | — | 0-20 | — | 0-20 |
| CoO | — | — | — | 0-5 | — | — |
| Fe₂O₃ | — | — | — | 0-5 | — | — |
| MnO | — | — | — | 0-10 | 0.5-1 | — |
| CeO₂ | — | — | — | — | 0-3 | — |
| F | — | — | 0-3.3 | 0-6 | — | — |

### Results

When examining the acoustic characteristics it was found that when determining the loudness the size of the measured substrate plates is important. Small plates of a size of 250×380 mm² show smaller loudness values than the normally used plates of 500×550 mm². By contrast, when measuring the acuteness, small and large plates within the scope of the measuring errors lead to the same results.

In Table 3 the results of measurements on small plates (250×380 mm²) are summarized. The surface occupancy at the examples according to Table 3 was 100%, thus no special pattern according to FIGS. 1 to 4 was selected so that the respective colors were tested independently from the influence of a pattern.

The comparison of the burnt-in colors 2, 3 and 5 show that with comparable Ra-values of 0.20 and 0.21 μm, respectively, shows significantly different acoustic characteristics. Color 4 having a very high Ra-value of 1.02 μm is significantly lower than the colors 2, 3, 5 with respect to loudness.

However, the roughness portions rms (10 . . . 20 mm⁻¹) (μm) and rms (20 . . . 50 mm⁻¹) (μm) correlate with the acuteness values. It can be seen that the color 6 with respect to the loudness as well as with respect to the acuteness shows the best values. Also the respective values of rms (10 . . . 20 mm⁻¹) and rms (20 . . . 50 mm⁻¹) correlate therewith, which with 0.0178 and 0.0048 μm are very low. Also the colors 1, 8 and in particular 10 must be seen as acceptable.

From the size of the pigments the parameters cannot be derived. So the acoustic characteristics of colors differed considerably, even in view of equal or similar roughness values Ra.

In addition also the occupancy value (surface occupancy), i.e. how many percent of the substrate surface were covered with decoration, in the range of 3% to 100% does not have a strong influence on the acoustic characteristics. Depending from the color even a decoration with a smaller occupancy value may have acoustic characteristics assessed more badly than e.g. a decoration coated with 100% of the same color. Herein in this surface occupancy the values for the acuteness vary by about 0.2 acum at most, with respect to the loudness by about 1 sone. Therefore the statements are valid for a wide range of surface occupancies of 3% to 100%.

The layer thicknesses of the burnt-in colors were between 1 and 10 μm.

In Table 4 the noise analyses are summarized which were performed on plates of the size of 500×550 mm². Herein the following standard deviations apply for the evaluation of a larger number of analyses: Loudness about 1.0 sone; acuteness about 0.1 to 0.2 acum. Herein also different patterns with different surface occupancies (3% to 50%) were used. Also movements of different speeds are given. The movements designated “slow” correspond to the movements mentioned above with 0.08 m/s, while the “fast” movements correspond to the movements mentioned above with 0.16 m/s leading to higher values with respect to loudness and acuteness.

Again color 6 shows the best results.

TABLE 3
Small plates (250 × 380 mm²) with 100% printing (influence of color independent
of pattern)

| CColor | 1 | 1a | 1b | 2 | 3 | 4 | 5 | 6 |
|---|---|---|---|---|---|---|---|---|
| Glass | Type A | Type A | Type A | Type A | Type A | Type A | Type A | Type A |
| flux | (composition | | | | (composition | | (composition | |
| | according | | | | according | | according | |
| | to | | | | to | | to | |
| | example | | | | example | | example | |
| | 3) | | | | 3) | | 3) | |
| Example | | 8 | 9 | 6 | | 2 | | 3 |
| D90 | 4 μm | 4 μm | 4 μm | 4 μm | 4 μm | 4 μm | 4 μm | 4 μm |
| Pigment | 20% | 10% | 5% | 15% | 10% | 30% | 2% | 0% |
| share | | | | | | | | |
| D90- | <1 μm | 2 μm | 2 μm | 4 μm | 4 μm | 4.5 μm | 30 μm | — |
| Pigment | | | | | | | | |
| Ra (μm) | 0.17 | 0.13 | 0.18 | 0.21 | 0.21 | 1.02 | 0.20 | 0.07 |
| Rz (μm) | 7 | 2.78 | 8.46 | 9.4 | 14.25 | 39.8 | 7.8 | 4.2 |
| Rms_{(2 . . . 10 mm-1)} | 0.140 | 0.103 | 0.142 | 0.185 | 0.228 | 0.320 | 0.251 | 0.076 |
| (μm) | | | | | | | | |
| Rms_{(10 . . . 20 mm-1)} | 0.0623 | 0.057 | 0.040 | 0.1310 | 0.0959 | 0.3208 | 0.091 | 0.0178 |
| (μm) | | | | | | | | |
| Rms_{(20 . . . 50 mm-1)} | 0.0404 | 0.035 | 0.0124 | 0.1212 | 0.0645 | 0.5473 | 0.045 | 0.0048 |
| (μm) | | | | | | | | |
| Loudness | 4.7 | 3.7 | 2.7 | 6.6 | 5.5 | 4 | 5 | 2.0 |
| (sone) | | | | | | | | |
| Sharpness | 2.6 | 2.8 | 2.5 | 3.1 | 2.7 | 3.6 | 3.1 | 2.2 |
| (acum) | | | | | | | | |
| Rating | + | ++ | ++ | − | + | + | + | ++ |
| (loudness) | | | | | | | | |
| Rating | + | + | ++ | − | + | −− | − | ++ |
| (acuteness) | | | | | | | | |

| CColor | 7 | 8 | 9 | 10 | 10a | 10b | 11 |
|---|---|---|---|---|---|---|---|
| Glass | | Type C | Type F | Type A | Type A | Type C | Composition |
| flux | | | (73% | | (composition | | according |
| | | | SiO₂ | | according | | to |
| | | | 7% | | to | | example. 7 |
| | | | Al₂O₃ | | example. | | |
| | | | 15% | | 4) | | |
| | | | B₂O₃ | | | | |
| | | | 4% | | | | |
| | | | R₂O + RO) | | | | |
| Example | 7 | 1 | | 4 | | 5 | |
| D90 | 10 μm | 4 μm | 4 μm | 4 μm | 4 μm | 4 μm | 4 μm |
| Pigment | 0% | 0% | 2% | 0% | 0% | 0% | 0% |
| share | | | | | | | |
| D90- | — | — | 30 μm | — | — | — | — |
| Pigment | | | | | | | |
| Ra (μm) | 2.5 | 0.24 | 0.25 | 0.2 | 0.2 | 0.27 | 0.49 |
| Rz (μm) | 42.4 | 7.67 | 8.6 | 1.54 | 1.63 | 8.4 | 9.1 |
| Rms_{(2 . . . 10 mm-1)} | 1.250 | 0.243 | 0.257 | 0.179 | 0.185 | 0.236 | 0.459 |
| (μm) | | | | | | | |
| Rms_{(10 . . . 20 mm-1)} | 1.1327 | 0.0958 | 0.125 | 0.019 | 0.024 | 0.098 | 0.2742 |
| (μm) | | | | | | | |
| Rms_{(20 . . . 50 mm-1)} | 1.3563 | 0.0355 | 0.077 | 0.010 | 0.017 | 0.042 | 0.1850 |
| (μm) | | | | | | | |
| Loudness | 9.3 | 5.1 | 6.6 | 3.2 | 3.5 | 5.5 | 6.7 |
| (sone) | | | | | | | |
| Sharpness | 3.3 | 2.8 | 3.4 | 2.3 | 2.4 | 2.6 | 3.0 |
| (acum) | | | | | | | |
| Rating | −− | + | − | ++ | ++ | + | − |
| (loudness) | | | | | | | |
| Rating | − | + | − | ++ | ++ | + | 0 |
| (acuteness) | | | | | | | |

TABLE 4
Results of topographical and noise analyses of plates of the
size 500 × 550 mm². Herein the averages are combined which
were computed from the line patterns from patterns for 4-8 (all
patterns > 3% occupancy), while the point patterns were
computed from pattern 9-16 (utilization of a steel enamel pot).

| Color | 6 | 2 | 1 | 4 | 3 |
|---|---|---|---|---|---|
| Loudness line pattern circle | 3.1 | 8.0 | 6.8 | 6.2 | 6.8 |
| average surface occupancy | | | | | |
| 3% . . . 50% slow - 0.08 m/s | | | | | |
| (sone) | | | | | |
| Loudness line pattern circle | 4.6 | 9.6 | 9.5 | 5.7 | 8.3 |
| average surface occupancy | | | | | |
| 3% . . . 50% schnell - 0.16 m/s | | | | | |
| (sone) | | | | | |
| Acuteness line pattern circle | 1.9 | 3.4 | 2.6 | 3.6 | 2.8 |
| average surface occupancy | | | | | |
| 3% . . . 50% slow - 0.08 m/s | | | | | |
| (acum) | | | | | |
| Acuteness line pattern circle | 2.3 | 3.8 | 3.0 | 3.6 | 2.9 |
| average surface occupancy | | | | | |
| 3% . . . 50% fast - 0.16 m/s | | | | | |
| (acum) | | | | | |
| Acuteness point pattern linear | 2.6 | 3.3 | 2.6 | 3.4 | 2.8 |
| motion average 8 variants - | | | | | |
| slow 0.08 m/s (acum) | | | | | |
| Rating | ++ | − | + | (+) | 0 |

Table 5 shows the results of the noise analyses for further examples. For the noise analyses the following standard deviations apply with the evaluation of a larger number of analyses: Loudness about 1.0 sone; acuteness about 0.1 to 0.2 acum; “fast” corresponds to a speed of 0.16 m/s, “slow” corresponds to a speed of 0.08 m/s—the standard is “slow”. Table 5 also reveals the observation that the loudness and acuteness values which are determined with a different pot (here: stainless steel pot when compared to a steel enamel pot) differ with respect to the absolute values, however that the sequence of the respective values within the frame of the standard deviation does not change. From this it follows that the “noise optimization” of a cooktop must not be determined “afresh” for each pot, instead the results that were collected for one pot can be transferred to the situation with different pots, and that within the light of this patent specification the cooktops designated as “noise-optimized” must be seen as “noise-optimized” for all types of pots.

The examples 10 and 10a are suited particularly well, wherein no pigments were admixed, by contrast the color bodies were crystallized within the decoration layer during the firing processes (after the smooth flowing of the glass frit).

TABLE 5

| Color | 7 | 9 | 5 | 11 | 8 | 10 | 10a |
|---|---|---|---|---|---|---|---|
| Loudness (sone) full | 6.8 | 5.5 | 4.3 | 5.4 | 5.1 | 2.9 | 3.4 |
| surface, small plates | | | | | | | |
| (stainless steel pot) | | | | | | | |
| Acuteness (acum) full | 3.5 | 3.7 | 3.2 | 3.2 | 3.2 | 2.7 | 2.6 |
| surface, small plates | | | | | | | |
| (stainless steel pot) | | | | | | | |
| Loudness (sone) full | 9.3 | 6.6 | 5.0 | 6.7 | 5.3 | 3.2 | 3.5 |
| surface, small plates | | | | | | | |
| (steel-enamel-pot) | | | | | | | |
| Acuteness (acum) full | 3.3 | 3.4 | 3.1 | 3.0 | 2.8 | 2.3 | 2.4 |
| surface, small plates | | | | | | | |
| (steel-enamel-pot) | | | | | | | |

### EXAMPLES

### Example 1

### Color 8

50 g of glass frit (glass C (specifications in wt.-%: 58% SiO₂, 6% Al₂O₃, 20% B₂O₃, 6% R₂O, 10% RO+RO₂; T_{g}=460° C., E_{w}=650° C.; with T_{g}=transition temperature and E_{w}=softening temperature), particle size D50=1.5 μm, D90=4 μm, agglomerate-free) ground within an attritor (dry) using a sifter were mixed with 60 g of screen printing paste medium, were dispersed and homogenized using a three-roller-mill so that no agglomerates were present. The resulting paste was applied onto a lithium aluminum silicate green glass of 4 mm thickness and transparently colored (140 fabric, full surface decoration on 250×380 mm²). A printed green glass plate was simultaneously burnt-in within the furnace and ceramized (Tₘₐₓ 935° C., holding time 10 min). The Rₐ-value of this plate was 0.24 μm; rms_{10 mm-1 . . . 20 mm-1}: 0.096 μm, rms_{20 mm-1 . . . 50 mm-1}: 0.0355 μm; the loudness value was 5.1 sone and the acuteness value 2.8 acum. A different green glass plate which was prepared identically was burnt-in at a lower maximum temperature also during the ceramization process (Tₘₐₓ 860° C., holding time 15 min). The Rₐ-value of this plate was 0.17 μm; rms_{10 mm-1 . . . 20 mm-1}: 0.11 μm, rms_{20 mm-1 . . . 50 mm-1}: 0.068 μm, the loudness value was 5.8 sone, and the acuteness value 3.1 acum. Although the glass frit was also molten here, due to the lower maximum temperature the values for the loudness and acuteness were worse.

### Example 2

### Color 4

For preparing color 4 35 G of a glass frit ground using an attritor (dry) with a sifter (glass A, specification in wt.-%: 52% SiO₂, 17% Al₂O₃, 19% B₂O₃, 4% R₂O, 8% RO+RO₂, T_{g}=580° C., E_{w}=750° C.), grain size D50=1.5 μm, D90=4 μm) were mixed with 65 g screen printing paste medium and 15 g structure-providing of homogenous sphere-shaped methylpolysiloxane particles of a particle size of 4.5 μm. This paste was homogenized using a dispersing machine for 10 minutes. Using a screen of size 140 one layer of the point pattern 11 and 12 of this color was applied by means of screen printing onto green glass (500 mm×550 mm, thickness 4 mm) and was dried at 180° C. for 30 minutes. The firing was performed at about 900° C. simultaneously with the ceramization of the green glass to yield a transparent glass ceramic. This burnt-in decoration was whitish, semi-transparent and matt. The Rₐ-value was 1.02 μm at both patterns, rms 10 mm⁻¹ . . . 20 mm⁻¹: 0.32 μm, rms 20 mm⁻¹ . . . . 50 mm⁻¹: 0.55 μm. The loudness and acuteness values at the point pattern 11 were: 5 sone and 3.6 acum; with the point pattern 12: 5 sone and 3.5 acum. The pot shifting noise was very acute, however quiet, and can therefore be applied as a signaling noise.

### Example 3

### Color 6

50 g of a glass frit (glass A, specifications in wt.-%: 52% SiO₂, 17% Al₂O₃, 19% B₂O₃, 4% R₂O, 8% RO+RO₂, T_{g}=580° C., E_{w}=750° C.), particle size D50=1.5 μm, D90=4 μm, agglomerate-free) ground within an attritor (dry) using a sifter were mixed with 60 g screen printing paste medium and were homogenized using a three-roller-mill so that no agglomerates were present. The resulting paste was applied by screen printing (140 screen, full surface decoration onto 250×380 mm² and with a point pattern 11 and 12 onto 500 mm×550 mm) onto an already ceramized, whitish, translucent glass ceramic plate of a thickness of 4 mm and was subsequently burnt-in at 850° C. for 1 hour. The Rₐ-value of the transparent glaze was 0.07 μm, rms_{10 mm-1 20 mm-1}: 0.018 μm, rms_{20 mm-1 . . . 50 mm-1}: 0.005 μm. The plate with the full surface decoration had a loudness of 2 sone and an acuteness of 2.2 acum. Comparable values of the acuteness were also obtained with the point pattern 11 and 12 (loudness 2.5 sone, acuteness 2.4 acum).

Color 6 showed the significantly best result with respect to the acoustic characteristics. Also the rms-values were accordingly low.

### Example 4

### Color 10

Into glass A (specifications in wt.-%: 52% SiO₂, 17% Al₂O₃, 19% B₂O₃, 4% R₂O, 8% RO+RO₂, T_{g}=580° C., E_{w}=750° C.), 25% TiO₂ were smelted so that the pigment fully dissolved within the glass melt at about 1450° C. and a homogenous glass resulted. From this 50 g were ground within an attritor (dry) using a sifter (particle size D50=1.5 μm, D90=4 μm, agglomerate-free) and were mixed with 75 g of screen printing paste medium and were homogenized by means of a three-roller-mill to that no agglomerates were present. The resulting paste was applied by means of screen printing (140 fabric, full surface decoration onto 250×380 mm²) onto a transparently colored green glass. The burning-in was performed simultaneously with the ceramization of the green glass to yield a dark glass ceramic (CERAN® Hightrans eco) (Tₘₐₓ 935° C., holding time 10 min), and the decoration had a light blue color. The Rₐ-value was 0.20 μm, rms_{10 mm-1 . . . 20 mm-1}: 0.019 μm, rms_{20 mm-1 . . . 50 mm-1}: 0.010 μm. The loudness was 3.2 sone, and the acuteness was 2.3 acum. Thus the requirements of a noise-optimized decoration were fulfilled.

### Example 5

### Color 10b

Into glass C (specifications in wt.-%: 58% SiO₂, 6% Al₂O₃, 20% B₂O₃, 6% R₂O, 10% RO+RO₂; T_{g}=460° C., E_{w}=650° C.) in addition 20% TiO₂ were smelted so that the pigment fully dissolved within the glass melt at about 1450° C. and a homogenous glass resulted. From this 50 g were ground in an attritor (dry) using a sifter (particle size D50=1.5 μm, D90=4 μm, agglomerate-free) and were mixed with 75 g of screen printing paste medium and were homogenized within a three-roller-mill so that no agglomerates were present. The resulting paste was applied onto a transparently colored green glass using screen printing (140 screen, full surface decoration onto 250×380 mm²). The burning-in was performed simultaneously with the ceramization of the green glass to yield a dark glass ceramic (CERAN® Hightrans eco) (Tₘₐₓ 935° C., holding time 10 min), and the decoration was light grey-white. The Rₐ-value was 0.27 μm, rms_{10 mm}⁻¹ _{. . . 20 mm}¹: 0.098 μm, rms_{20 mm-1 . . . 50 mm-1}: 0.042 μm. The loudness was 5.5 sone, and the acuteness 2.6 acum. Thus the requirements of a noise-optimized decoration were fulfilled.

### Example 6

### Color 2

For preparing color 2 42.5 g of a ground glass frit (wet grinding) (specifications in wt.-%: glass A (52% SiO₂, 17% Al₂O₃, 19% B₂O₃, 4% R₂O, 8% RO+RO₂, T_{g}=580° C., E_{w}=750° C.), particle size D50=1.5 μm, D90=4 μm) will mix with 7.5 g of a pigment mixture of white and black pigments (particle size D90=4 μm) and mixed with 60 g of screen printing paste medium. This paste was homogenized by means of a three-roller-mill. Using screen printing (140 screen) strip patterns 4 and 6 were printed onto a transparently colored green glass (500×550×4 mm³). The burning-in was performed simultaneously with the ceramization of the green glass to yield a dark glass ceramic (CERAN® Hightrans eco) (Tₘₐₓ 935° C., holding time 10 min). The burnt-in decorations were grey, the Rₐ-value was 0.21 μm, rms_{10 mm-1 . . . 20 mm-1}: 0.13 μm, rms_{20 mm-1 . . . 50 mm-1}: 0.12 μm, with both patterns. The loudness and acuteness values with both strip patterns were 10.1 sone, 4.0 acum (4) and 9.9 sone/3.5 acum (6). These decorations did not fulfill the requirements of a noise-optimized decoration.

### Example 7

### Color 7

50 g of a glass frit ground within an attritor (dry) using a sifter (specifications in wt.-%: 80% SiO₂, 2% Al₂O₃, 14% B₂O₃, 4% R₂O), particle size D90=10 μm) were mixed with 60 g of screen printing paste medium and were homogenized within a three-roller-mill so that almost no agglomerates were present anymore. The resulting paste was applied onto an already ceramized white glass ceramic plate of a thickness of 4 mm using screen printing (140 screen, full surface decoration onto 250×380 mm²) and was subsequently burnt in at 950° C. for 1 hour. The Rₐ-value of the whitey, transparent, non-pigmented glaze was 2.5 μm, rms_{10 mm-1 . . . 20 mm-1}: 0.096 μm, rms_{20 mm-1 . . . 50 mm-1}: 0.0355 μm, the loudness was 9.3 sone and the acuteness 3.3 acum. This decoration does not fulfill the requirements of a noise-optimized decoration.

### Example 8

### Color 1a

45 g of a glass frit ground within an attritor (dry) using a sifter (glass A, specifications in wt.-%: 52% SiO₂, 17% Al₂O₃, 19% B₂O₃, 4% R₂O, 8% RO+RO₂, T_{g}=580° C., E_{w}=750° C.) with a particle size D50=1.5 μm, D90=4 μm, agglomerate-free) were mixed with 5 g of a pigment mixture with D90=2 μm and with 60 g screen printing medium and were homogenized within a three-roller-mill so that no agglomerates were present anymore. The resulting paste was applied by screen printing (140 screen, full surface decoration onto 250×380 mm²) onto a transparent glass plate with a thickness of 4 mm and was subsequently burnt in while ceramizing the glass plate to a transparent glass ceramic (Tₘₐₓ 935° C., holding time 10 min). The Rₐ-value of the glaze was 0.13 μm, rms_{10 mm-1 . . . 20 mm-1}: 0.057 μm, rms_{20 mm-1 . . . 50 mm-1}: 0.035 μm. The plate with the full surface decoration had a loudness of 3.7 sone and an acuteness of 2.8 acum and thus fulfills the requirements of a noise-optimized decoration.

### Example 9

### Color 1b

47.5 g of a glass frit ground within an attritor (dry) using a sifter (glass A, specifications in wt.-%: 52% SiO₂, 17% Al₂O₃, 19% B₂O₃, 4% R₂O, 8% RO+RO₂, T_{g}=580° C., E_{w}=750° C.), particle size D50=1.5 μm, D90=4 μm, agglomerate-free) were mixed with 2.5 g of a pigment mixture with D90=2 μm and 60 g of screen printing medium and were homogenized by means of a three-roller-mill so that no agglomerates were present anymore. The resulting paste was applied by screen printing (140 screen, full surface decoration onto 250×380 mm²) onto a transparent glass ceramic plate of a thickness of 4 mm and was subsequently burnt in at 850° C. for 1 hour. The Rₐ-value of the glaze was 0.18 μm, rms_{10 mm-1 . . . 20 mm-1}: 0.04 μm, rms_{20 mm-1 . . . 50 mm-1}: 0.012 μm. The plate with the full surface decoration had a loudness of 2.7 sone and an acuteness of 2.5 acum and thus fulfills the requirements of a noise-optimized decoration.

When summarizing it must be concluded that there is a variety of possibilities to improve the acoustic characteristics.

Although it is possible to obtain colors with low Rₐ-values (<0.3 μm) with small particle sizes of glass flux and pigment (e.g. D90≦4 μm), however a substantial influence on the acoustic characteristics in particular have the agglomerates. The agglomerates of a color can be reduced by selected method parameters, starting with the preparation of the starting materials as well as by the homogenizing and dispersing to yield a color paste. The color pastes must essentially be free of agglomerates>20 μm, preferably >10 μm, particularly preferred >5 μm.

For avoiding agglomerates in particular dry grinding methods are preferred.

Also important is the adaptation of the firing parameters to the substrate and to the respective color for generating the desired optimized acoustic characteristics. Basically, the color can be burnt in over a considerably large parameter range to fulfill the characteristics which are desired e.g. for a decorated cooktop. However, for the acoustic characteristics the range must be selected so that the glass flux is fully molten, the pigments are well embedded within the flux and so that further effects such as the modification of the surface by evaporation processes, surface crystallization of the glass flux, floating of the pigments, are avoided.

In this regard from the different investigations it is followed that obviously decorations without additions of pigments are particularly well suited (color 6). Also color 8 (without pigment additions) shows relatively good results. Also colors having a small pigment proportion (in combination with other measures) lead to improved noise characteristics (color 1b).

Also color 10, wherein the color body crystallizes within the base glass layer showed good results. This is due to the fact that in this way it is avoided that non-molten pigment particles are present at the decoration surface which could influence a noise generation detrimentally.

What is claimed is:

1. A coated substrate, comprising a noise-optimized glass-based decoration, having at least an acuteness<3 acum or a loudness<7 sone, measured according to DIN 45631/A1:2010-03 and DIN 45692:2009-08 on said substrate with outer dimensions 500×550 mm² coated with said decoration, while displacing a steel-enamel pot at a speed of 0.08 m/s on said coated substrate, said steel-enamel pot having an enamel bottom with a diameter of the stand bottom of 17 cm, a height of 8.5 cm, an inner diameter at the upper rim of 20 cm, having an empty mass of 1.6 kg and an extra mass of 1 kg received within the inside, said enamel bottom having a Vicker's hardness of 635±50 HV 0.1/10 according to DIN EN ISO 6507-1 and a roughness Ra between 0.2 and 0.9 μm according to DIN EN ISO 4288:1998.

2. The substrate of claim 1, wherein said substrate has an acuteness<3 acum and has a loudness<7 sone.

3. A coated substrate, comprising a noise-optimized glass-based decoration, wherein said decoration has a roughness portion determined by white light interference microscopy rms in the range of 10 mm⁻¹ to 20 mm⁻¹ being smaller than 0.1 micrometers, and a roughness portion rms in the range of 20 mm⁻¹ to 50 mm⁻¹ being smaller than 0.045 micrometers.

4. The substrate of claim 1, wherein said decoration has a roughness portion determined by white light interference microscopy rms in the range of 10 mm⁻¹ to 20 mm⁻¹ being smaller than 0.1 micrometers, and a roughness portion rms in the range of 20 mm⁻¹ to 50 mm⁻¹ being smaller than 0.045 micrometers.

5. The substrate of claim 1, wherein said decoration comprises a burnt-in glass frit selected form the group consisting of a silicate glass, a borosilicate glass, a zinc silicate glass, a zinc borate glass, a zinc borosilicate glass, a bismuth borosilicate glass, a bismuth borate glass, a bismuth silicate glass, a phosphate glass, a zinc phosphate glass, an aluminosilicate glasses, a lithium aluminosilicate glass, and mixtures thereof.

6. The substrate of claim 1, wherein said decoration comprises a burnt-in glass frit comprises additives selected form the group consisting of pigments, fillers, structure-providing particles, and mixtures thereof.

7. The substrate of claim 1, consisting of a glass ceramic.

8. The substrate of claim 1, consisting of a lithium aluminum silicate glass ceramic for application as a variable cooktop.

9. The substrate of claim 1, wherein said substrate has a coefficient of thermal expansion in the range of 20-300° C. of ≦5×10⁻⁶/K.

10. A method of decorating a substrate with a noise-optimized glass-based decoration having a small acuteness and loudness, wherein a glass frit is ground to a particle size of D90 of 10 nanometers to 50 micrometers, is mixed with a dispersing medium and is homogenized substantially agglomerate-free, is thereafter applied to a surface of said substrate and burnt-in so that said decorated substrate has a roughness portion determined by white light interference microscopy rms in the range of 10 mm⁻¹ to 20 mm⁻¹ being smaller than 0.1 micrometers and a roughness portion rms in the range of 20 mm⁻¹ to 50 mm⁻¹ being smaller than 0.045 micrometers.

11. The method of claim 10, wherein said glass frit is burnt-in so that said coated substrate has an acuteness<3 acum and a loudness<7 sone, measured according to DIN 45631/A1:2010-03 and DIN 45692:2009-08 on said substrate with outer dimensions 500×550 mm² coated with said decoration, while displacing a steel-enamel pot at a speed of 0.08 m/s on said coated substrate, said steel-enamel pot having an enamel bottom with a diameter of the stand bottom of 17 cm, a height of 8.5 cm, an inner diameter at the upper rim of 20 cm, having an empty mass of 1.6 kg and an extra mass of 1 kg received within the inside, said enamel bottom having a Vicker's hardness of 635±50 HV 0.1/10 according to DIN EN ISO 6507-1 and a roughness Ra between 0.2 and 0.9 μm according to DIN EN ISO 4288:1998.

12. The method of claim 10, wherein said grinding and homogenizing of said glass frit is performed so that substantially no agglomerates>20 micrometers are present.

13. The method of claim 10, wherein a dry grinding process is used for grinding said glass frit.

14. The method of claim 10, wherein the glass frit is mixed with additives and is homogenized therewith.

15. The method of claim 14, wherein said additives comprise fillers selected from the group consisting of SiOₓ particles, aluminum oxide particles, pyrogenic silicic acids, lime natron particles, alkali aluminosilicate particles, polysiloxane spheres, borosilicate glass spheres, hollow glass spheres, and mixtures thereof.

16. The method of claim 14, wherein said additives comprise color-providing pigments selected form the group consisting of cobalt oxides/spinels, cobalt aluminum spinels, cobalt aluminum zinc oxides, cobalt aluminum silicon oxides, cobalt titanium spinels, cobalt chromium spinels, cobalt aluminum chromium oxides, cobalt nickel manganese iron chromium oxides/spinels, cobalt nickel zinc titanium aluminum oxides/spinels, chromium iron nickel manganese oxides/spinels, cobalt iron chromium oxides/spinels, nickel iron chromium oxides/spinels, iron manganese oxides/spinels, iron oxides, iron chromium oxides, iron chromium zinc titanium oxides, copper chromium spinels, nickel chromium antimony titanium oxides, titanium oxides, zirconium silicon iron oxides/spinels, plate-shaped or pin-shaped pigments, coated effect pigments, and mixtures thereof.

17. The method of claim 14, wherein to said glass frit after grinding a maximum of 20 wt.-% of anorganic additives comprising fillers or pigments are admixed.

18. The method of claim 14, wherein anorganic additives comprising pigments or fillers are admixed, are molten together with the glass flux and are ground, before said decoration is applied to a surface of said substrate.

19. The method of claim 14, wherein anorganic additives and organic additives are added to said glass frit and are homogenized to form a paste, said paste is applied to a surface of said substrate by a method selected from the group consisting of screen printing and ink-jet printing, and is burnt-in thereafter.

20. The method of claim 10, wherein a liquid coating method is used for applying said decoration onto said substrate surface, said substrate consisting of a crystallizable glass provided in its green glass state, wherein said decoration after applying onto said substrate is burnt-in using a temperature range of 600° C. to 1200° C., for 1 minute to 4 hours, while simultaneously ceramizing said green glass of said substrate to a glass ceramic.
